(19) United States
(12) Patent Application Publication
(10) Pub. No.: US 2026/0042617 A1
(43) Pub. Date: Feb. 12, 2026

(54) APPARATUS AND METHOD FOR TRANSPORTING OBJECTS

(71) Applicant: KRONES AG, Neutraubling (DE)

(72) Inventors: Michael NEUBAUER, Grassau (DE); Stefan POESCHL, Sinzing (DE)

(21) Appl. No.: 19/295,076

(22) Filed: Aug. 8, 2025

(30) Foreign Application Priority Data
Aug. 9, 2024 (DE) 10 2024 122 760.5

(51) Int. Cl. B65G 47/90; F16J 15/40

(52) U.S. Cl. CPC B65G 47/90; F16J 15/40

(57) ABSTRACT

The invention relates, inter alia, to an apparatus for transporting objects. A sealing device seals between a first space and a second space and has a liquid channel for accommodating a sealing liquid for sealing. A conveying device has at least one movement apparatus for transporting an object. The at least one movement apparatus has an object holder which is arranged in the second space. The at least one movement apparatus has a connecting region for guiding, driving and/or supporting the respective movement apparatus, which is arranged in the first space. The at least one movement apparatus has a support connection which connects the connecting region and the object holder to one another. A section of the support connection extends through the liquid channel for immersion in the sealing liquid.

### CROSS REFERENCE TO RELATED APPLICATIONS

This application claims the benefit under 35 U.S. C. § 119(a) of German Patent Application No. DE 10 2024 122 760.5, filed Aug. 9, 2024, entitled APPARATUS AND METHOD FOR TRANSPORTING OBJECTS, and whose entire disclosure is incorporated by reference herein.

### TECHNICAL FIELD

The invention relates to an apparatus for transporting objects, preferably containers. The invention further relates to a container treatment system having such an apparatus. The invention further relates to a method for transporting objects, preferably containers.

### TECHNICAL BACKGROUND

In a container treatment system, containers can be treated and transported between the individual parts of the system. A variety of techniques are known for transporting the containers.

For example, EP 3 597 549 A1 discloses a container treatment machine comprising a carousel with container treatment stations and a long stator linear motor. The long stator linear motor is arranged so that movers running on it can run in a section of the circumference of the carousel with containers that are being transported or can be transported on the carousel.

The use of rollers to guide and support the movers/shuttles, which is necessary due to a lack of alternatives, has certain disadvantages. For example, the rollers wear out during operation. This results in roller abrasion. It may be necessary to lubricate the rollers to increase their service life. These disadvantages are particularly undesirable in filling machines, for example, and in particular in aseptic filling machines, as they can cause hygienic problems and contamination of the filling material.

The invention is based on the object of creating an improved technique for transporting objects, preferably containers. Preferably, at least some of the disadvantages mentioned above should be overcome. Preferably, the technology should enable improved hygiene, e.g., for aseptic applications.

### SUMMARY OF THE INVENTION

The object is achieved by the features of the independent claims. Advantageous developments are specified in the dependent claims and the description.

One aspect relates to an apparatus for transporting objects, preferably containers. The apparatus has a (e.g., stationary) sealing device, preferably a so-called water lock. The sealing device seals between a first space and a second space and has a preferably circumferential (e.g., stationary) liquid channel for receiving a sealing liquid (e.g., sealing liquid bath) for sealing. The apparatus further comprises a conveying device having at least one movement apparatus for transporting an object. The at least one movement apparatus (e.g., mover/shuttle or carrier) has an object holder for holding the object, wherein the object holder is arranged in the second space. The at least one movement apparatus further comprises a connecting region for guiding, driving and/or supporting the respective movement apparatus, which is arranged in the first space. The at least one movement apparatus further comprises a support connection which connects the connecting region and the object holder to one another, wherein a section of the support connection extends through the liquid channel for immersion in the sealing liquid (e.g., beveled, preferably transversely, to a longitudinal course of the liquid channel).

Advantageously, the apparatus enables objects, such as containers, to be transported without hygienic risks, e.g., in a beverage bottling system and/or an aseptic system. For transport, movement apparatuses can be used which, in principle, can be driven in any way, since their drive does not affect the hygiene in the second space. At the same time, the drive technology, etc., can be protected by the sealing device against aggressive gases and other media that are used in the second space, e.g., for treating the objects. Compared to a solution in which the conveying device is located entirely in the second space (e.g., clean room), the part of the conveying device in the first space does not need to be continuously and laboriously cleaned in order not to impair the hygienic conditions in the second space. It is therefore advantageous to use a less complex and less expensive conveying device that is not specially designed for hygienic applications (e.g., no special materials and no encapsulation required). Advantageously, the use of the liquid channel also allows a preferred overpressure to be maintained in the second space, which would be very difficult to achieve, for example, if a gap seal were used. Advantageously, the second space does not have to be opened to maintain and repair the conveying device, which reduces the risk of contamination in the second space.

In an exemplary embodiment, the conveying device comprises several movement apparatuses which can preferably be driven individually (e.g., magnetically or electromagnetically) and/or moved independently of one another (e.g., along a guideway) (e.g., controlled by a control device or a processing device). Alternatively, or additionally, the conveying device can be a long stator linear motor conveying device, a short stator linear motor conveying device or a planar motor conveying device. This advantageously allows the movement apparatuses to be moved individually as required while permanently maintaining hygienic conditions within the second space. At the same time, the long stator, short stator or planar motor, as well as any guide elements such as rollers, including lubrication, are advantageously protected against aggressive gases and media that may be used in the second space.

It is possible that the connecting region has at least one (e.g., permanent) magnet via which the respective movement apparatus can be driven.

In a further exemplary embodiment, the conveying device comprises a circulating conveying element, preferably a chain, belt or ring body, wherein the circulating conveying element is connected to the at least one movement apparatus (e.g., the connecting region and/or for carrying the respective movement apparatus). Advantageously, the apparatus also enables not only new drive technologies, such as long stator linear motors, to be easily and hygienically connected to the second space for transporting the objects, but also conventional drive technologies, such as chain or belt drives.

In one embodiment, the conveying device has a, preferably circulating, guideway (e.g., roller track, slideway or rail) arranged in the first space. Preferably, the connecting region of the respective movement apparatuses has at least one guide element (e.g., roller or sliding shoe), which is guided on the guideway for guiding the respective movement apparatus along the guide track. The at least one guide element is arranged in the first space. Advantageously, for example, a lubricant can be used to lubricate the guideway and the guide elements in the first space without causing any hygienic impairment in the second space.

In a further embodiment, at least one of the following conditions is met:
the guideway and the liquid channel extend next to one another, preferably as substantially parallel curves;
the liquid channel is arranged on the outside or inside of the guideway; and
the at least one guide element carries the respective movement apparatus on the guideway.

In an embodiment variant, at least one of the following is fulfilled:
a cross-section of the liquid channel and a longitudinal course of the section of the support connection are structurally adapted to each other for immersion of the section in the sealing liquid;
the liquid channel has a substantially U-shaped or substantially V-shaped cross-section;
the section of the support connection has a substantially U-shaped or substantially V-shaped longitudinal course; and
the liquid channel is filled or can be filled with the sealing liquid, preferably comprising water and/or a sterilizing agent and/or disinfectant.

On the one hand, this can advantageously achieve a reliable and effective sealing between the first space and the second space. On the other hand, this can advantageously enable the smallest possible volume of the liquid channel.

In an exemplary embodiment, the liquid channel is open at the top, the support connection is immersed in the liquid channel from above in the first space for immersion in the sealing liquid, and the support connection is immersed in the liquid channel from above in the second space for immersion in the sealing liquid. This advantageously allows a reliable and effective sealing to be achieved between the first space and the second space.

In a further exemplary embodiment, the sealing device has a partition wall which separates the first space and the second space from one another and which, preferably from above, is immersed in the liquid channel for immersion in the sealing liquid (e.g., substantially centrally). Preferably, at least one of the following conditions is also met:
the partition wall is stationary;
the partition wall is circumferential;
a section of the partition wall immersed in the liquid channel and the liquid channel together form a siphon;
a longitudinal course of the partition wall extends as a parallel curve to the liquid channel; and
a preferably circumferential splash guard is connected to the partition wall to prevent sealing liquid from splashing out of the liquid channel, preferably in the second space.

In one embodiment, the sealing device comprises at least one damping element (e.g., wave breaker) formed in the liquid channel for damping waves of the sealing liquid caused by the movement of the support connection in the liquid channel. Preferably, at least one of the following conditions is also met:
several damping elements are comprised, which are arranged distributed along a longitudinal course of the liquid channel;
the at least one damping element is rod-shaped, plate-shaped and/or block-shaped;
the at least one damping element is arranged in a curved section of the liquid channel; and
the at least one damping element is arranged in an edge region of the fluid channel to leave a movement corridor for the section of the support connection (e.g., substantially centrally through the fluid channel).

This advantageously prevents the sealing liquid from spilling over and still allows high transport speeds and dynamics when transporting the objects.

In a further embodiment, at least one of the following conditions is met:
the section of the support connection has a flow-optimized shape in order to minimize wave formation when moving through the sealing liquid;
the section of the support connection is designed as a curved sheet, a bracket or an open frame;
the section of the support connection is flattened; and
a side of the section of the support connection facing in a forward movement direction of the respective movement apparatus is rounded or tapered.

This advantageously prevents the sealing liquid from spilling over and still allows high transport speeds and dynamics when transporting the objects. Advantageously, frictional resistance when moving through the sealing liquid can also be reduced, which can save energy for driving the at least one movement apparatus.

In an embodiment variant, the apparatus further comprises an adjusting device which is configured to move the object holder at an angle, preferably transversely, to a longitudinal course of the liquid channel, preferably to displace it (e.g., in a horizontal direction) and/or to pivot it. Advantageously, the objects can thus be moved in at least one additional dimension in the second space without compromising hygiene conditions. Advantageously, this can enable, for example, a supply to a treatment station, an object transfer and/or an object handover.

In a further embodiment variant, at least one of the following conditions is met:
the adjusting device is integrated in the at least one movement apparatus, preferably in the support connection, or the adjusting device is configured for moving (e.g., displacing and/or pivoting) at least one section of a guideway of the conveying device on which the at least one movement apparatus is guided, and/or a section (e.g., a long stator segment) of the long stator associated (e.g., with the section of the guideway);
the adjusting device is arranged in the first space and/or the liquid channel;
the adjusting device is a displacement device and/or a pivoting device; and
the liquid channel has a widened channel section for receiving the section of the support connection within a movement space for the section of the support connection which can be effected by the adjusting device.

Advantageously, this allows a desired adjustment of the objects via the adjusting device without the need for any hygienic intervention in the second space.

In an exemplary embodiment, at least one of the following is also met:
the second space is a processing space in which the objects can be treated;
the second space is a clean room, which is preferably applied with or can be applied with filtered air, sterile air and/or an overpressure;
the first space is a drive space in which drive technology, preferably lubricated, is arranged for driving the at least one movement apparatus, and
the first space is open to the surroundings.

In a further exemplary embodiment, at least one of the following conditions is also met:
the object holder is a container holder for holding a container, preferably on a container neck, a container neck ring, a container shell and/or a container bottom of the container;
the object holder has a sliding element for sliding an object; and
the object holder has a, preferably active or passive, clamp, preferably a container clamp.

A further aspect relates to a container treatment system comprising an apparatus as disclosed herein and a container treatment apparatus for treating containers, which is arranged at least in sections in the second space. The at least one movement apparatus is movable (e.g., controlled by a control device or a processing device) for transporting an object designed as a container to the container treatment apparatus, along the container treatment apparatus and/or away from the container treatment apparatus. Preferably, the container treatment apparatus is:
a container production apparatus for producing the containers,
a coating apparatus for coating the containers,
a cleaning apparatus (e.g., with rinsing nozzles and/or immersion bath) for cleaning the containers,
a sterilization apparatus (e.g., with sterilization nozzles) for sterilizing the containers,
a filling apparatus (e.g., with filling valves) for filling the containers with a (e.g., liquid or pasty) filling material,
a closing apparatus (e.g., with closing heads) for closing the containers,
a labeling apparatus (e.g., with labeling units) for labeling the containers, or
a printing apparatus (e.g., with print heads) for printing on the containers.

For example, the containers can be realized as bottles, cans, canisters, cartons, vials, tubes, etc.

A further aspect relates to a method for transporting objects, preferably containers, and/or via an apparatus as disclosed herein (or in a container treatment system as disclosed herein). The method comprises the following:
sealing between a first space and a second space via a liquid channel of a sealing device filled with a sealing liquid (e.g., sealing bath);
transporting an object within the second space via an object holder of a movement apparatus of a conveyor device, wherein the movement apparatus is guided, driven and/or supported via a connecting region of the movement apparatus which is arranged in the first space, and the movement apparatus comprises a support connection which connects the object holder and the connecting region and comprises a section which is immersed in the sealing liquid; and optionally
treating (e.g., producing, coating, cleaning, sterilizing, filling, closing, labeling, decorating and/or printing) of the transported object in the second space, preferably via a container treatment apparatus.

Advantageously, the method can be used to achieve the same advantages that have already been described with reference to the apparatus.

It is to be understood that all features mentioned herein with respect to the apparatus and the container treatment system are also disclosed and claimable in connection with the method disclosed herein, and vice versa.

The preferred embodiments and features of the invention described above can be combined with one another as desired.

### BRIEF DESCRIPTION OF THE FIGURES

Further details and advantages of the invention are described below with reference to the accompanying drawings. In the figures:

FIG. 1 is a perspective sectional view of an apparatus for transporting containers in accordance with an exemplary embodiment;

FIG. 2 is a sectional view of a region of the exemplary apparatus of FIG. 1;

FIG. 3 is a perspective view of a movement apparatus in accordance with an exemplary embodiment;

FIG. 4 is a perspective view of a movement apparatus in accordance with a further exemplary embodiment;

FIG. 5 is a perspective view of a movement apparatus in accordance with a further exemplary embodiment;

FIG. 6 is a perspective view of a region of a liquid channel of a sealing device in accordance with an exemplary embodiment;

FIG. 7 is a sectional view of a region of an apparatus for transporting containers in accordance with a further exemplary embodiment; and

FIG. 8 is a sectional view of the region of an exemplary apparatus of FIG. 7 with an adjusted object holder.

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EMBODIMENTS

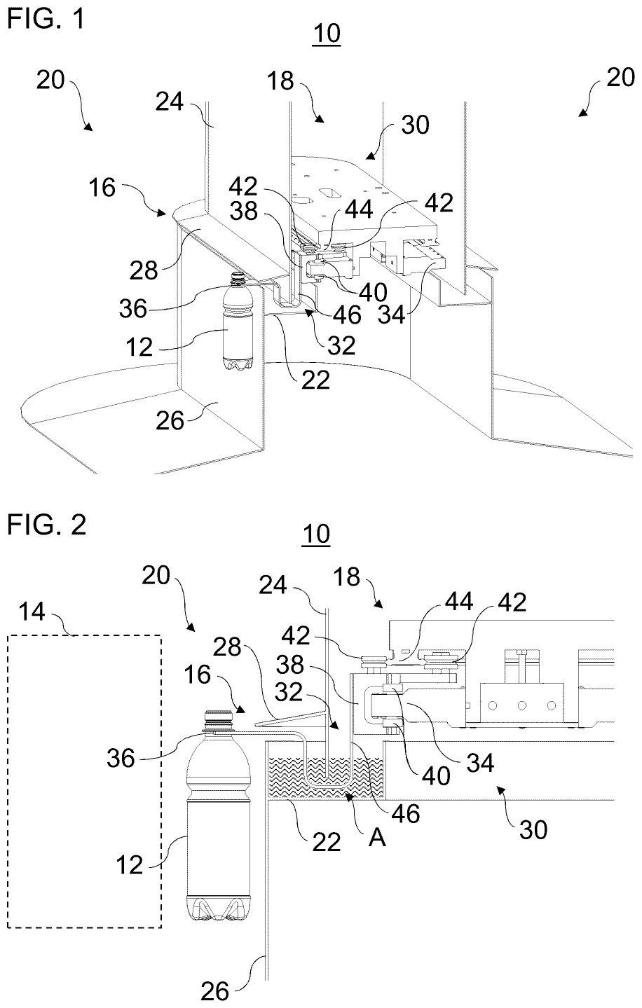

FIGS. 1 and 2 show an apparatus 10 for transporting objects 12. The preferred objects are 12 containers. However, the techniques disclosed herein may also be applied to transport other objects.

The apparatus 10 may, for example, be comprised in a container treatment system, e.g., a beverage filling system. For example, the apparatus 10 may be arranged in the container treatment system for transporting containers.

For example, the apparatus 10 can transport containers to a container treatment apparatus 14 and/or transport them away from the container treatment apparatus 14 (only shown schematically in FIG. 2). The container treatment apparatus 14 can receive the containers from the apparatus 10 for treatment and/or transfer the containers to apparatus 10 after treatment. Alternatively, the container treatment apparatus 14 can treat the containers while they are held by the apparatus 10. It is also possible that the apparatus 10 and the container treatment apparatus 14 are integrated with each other. The apparatus 10 can transport the containers, for example, through or along the container treatment apparatus 14.

The container treatment apparatus 14 may be any apparatus in a container treatment system for treating containers. For example, the container treatment apparatus 14 may be a container producing apparatus, a coating apparatus, a cleaning apparatus, a sterilizing apparatus, a filling apparatus, a closing apparatus, a labeling apparatus, or a printing apparatus.

The apparatus 10 comprises a sealing device 16 and a conveying device 30 with at least one movement apparatus 32. Preferably, the conveying device 30 can also have a guideway 44 on which the at least one movement apparatus 32 is guided.

The sealing device 16 seals between a first space 18 and a second space 20.

The first space 18 may, for example, be open to the environment or closed to the environment. For example, the first space 18 may be a drive space. For example, a lubricated drive technology of the conveying device 30 can be arranged in the drive space.

It is possible that the first space 18 has an exhaust air device (not shown in the figures). The exhaust air device may, for example, comprise a fan or blower with which air can be removed from the first space 18. This air from the first space 18 may be contaminated due to operational reasons, for example with very fine droplets of lubricant or sterilizing agent or evaporated sterilizing agent.

Preferably, the second space 20 may be a processing space and/or clean room in which the objects 12 are treated. The clean room can also be called an isolator. The clean room can be substantially free or low in particles (e.g., particles of all types and sizes). Sterile clean room conditions may prevail in the clean room. The clean room may also be designed or referred to as a sterile space or aseptic space, as it is preferably substantially free of microorganisms.

Preferably, the clean room can be applied with sterile air (clean room air). Preferably, the clean room can be applied with sterile air in such a way that an air pressure within the clean room is greater than in an environment of the clean room or outside the clean room, e.g., in the first space 18. The clean room can, for example, receive sterile air from a sterile air source. The sterile air source may, for example, comprise at least one air filter and/or an air conveying device, e.g., a blower or compressor. Preferably, the clean room may have an inlet lock for the objects 12 and/or an outlet lock for the objects 12. It is possible that the conveying device 30 or another conveying device is arranged to transport the objects 12 through the inlet lock and/or the outlet lock. It is also possible for the objects 12 to be treated, e.g., sprayed or misted, with a sterilization medium, e.g., containing hydrogen peroxide or peracetic acid, in the inlet lock or upstream of it for sterilization.

Particularly preferably, the sealing device 16 is designed as a so-called water lock, as explained below by way of example.

The sealing device 16 comprises a liquid channel 22 for sealing between the first space 18 and the second space 20. Preferably, the sealing device 16 may further comprise at least one partition wall 24, 26 for sealing between the first space 18 and the second space 20.

The liquid channel 22 is configured to receive a sealing liquid A (only shown in FIG. 2). During operation, the liquid channel 22 is filled with the sealing liquid A. Preferably, the sealing liquid A is accommodated in the liquid channel 22 in the form of a sealing liquid bath. The sealing liquid A can be, for example, water or water mixed with a sterilization medium and/or a disinfection medium or another (e.g., sterilization or disinfection) liquid.

For example, the sealing device 16 may comprise a liquid source and a level sensor (both not shown in the figures). The liquid source can provide the sealing liquid A. The level sensor can detect a level of the sealing liquid A in the liquid channel. Depending on the detected level, sealing liquid can be supplied from the liquid source to the liquid channel 22 to maintain a desired level, for example, controlled by a control device of the apparatus 10.

Preferably, the liquid channel 22 has a substantially U-shaped or a substantially V-shaped cross-section. The liquid channel 22 may be open at the top.

Preferably, the liquid channel 22 is circumferential. A longitudinal course of the liquid channel 22 can be adapted as desired to the respective requirements. For example, the liquid channel 22 may have a substantially circular ring shape or an oval shape (e.g., with straight sections).

Preferably, a longitudinal course of the liquid channel 22 may extend as a, preferably closed, parallel curve to the guideway 44 or to a longitudinal course of the guideway 44. For example, the circumferential liquid channel 22 may extend outside or inside the circulating guideway 44.

For example, the liquid channel 22 can be designed as a liquid tray with a central recess. The recess may, for example, be annular, oval, or substantially rectangular (e.g., with rounded corners). The first space 18 may, for example, be arranged in the central recess.

The at least one partition wall 24, 26 may separate the first space 18 and the second space 20. The at least one partition wall 24, 26 is preferably vertically aligned or is a vertical partition wall. The at least one partition wall 24, 26 may, for example, be a sheet partition wall and/or have window(s) and/or door(s). The at least one partition wall 24, 26 is preferably stationary.

Preferably, the at least one partition wall 24, 26 can be a circumferential partition wall. For example, a longitudinal course of the at least one partition wall 24, 26 may extend as a parallel curve to the liquid channel 22 (or a longitudinal course of the liquid channel 22) and/or the guideway 44 (or a longitudinal course of the guideway 44).

Preferably, the partition wall 24 can be arranged directly above the liquid channel 22. The partition wall 24 may preferably be arranged substantially centrally above the liquid channel 22.

The partition wall 24 preferably protrudes from above into the liquid channel 22 or is immersed therein, preferably without touching a base/bottom of the liquid channel 22. The partition wall 24 can be immersed in the sealing liquid A in the liquid channel 22. For example, a hermetic separation of the first space 18 and the second space 20 can be achieved in this way.

Preferably, a lower, preferably circumferential, end section of the partition wall 24 can be arranged within the liquid channel 22 or can be immersed in the sealing liquid A. Preferably, the section of the partition wall 24 immersed in the liquid channel 22 and the liquid channel 22 (with the sealing liquid A accommodated therein) together form a siphon.

The further partition wall 26 may be arranged laterally adjacent to and/or below the liquid channel 22. For example, the partition wall 24 may extend from the liquid channel 22 to a bottom region of the apparatus 10.

It is possible that the sealing device 26 may also have a splash guard 28, for example. Preferably, the splash guard 28 can be arranged in the second space 20 and/or above the liquid channel 22. The splash guard 28 can be configured to prevent sealing liquid A from splashing out of the liquid channel 22 into the second space 20 or at least reduce said splashing. The splash guard 68 can, for example, extend beveled or horizontally over a section of the liquid channel 22.

The splash guard 28 can, for example, be designed as a circumferential splash guard. For example, a longitudinal course of the splash guard 28 can extend as a parallel curve to the liquid channel 22.

The splash guard 28 can be connected to the partition wall 24. Preferably, the splash guard 28 can extend from the partition wall 24 over a section of the liquid channel 22. For example, the splash guard 28 may be supported on the partition wall 24 and/or be integrally formed with the partition wall 24. For example, the splash guard 28 can be configured as an apron running along the partition wall 24.

In the following, the conveying device 30 is described by way of example with reference to FIGS. 1 to 3.

As already mentioned, the conveying device 30 comprises the at least one movement apparatus 32. The objects 12 are transported via the at least one movement apparatus 32. It is possible for a movement apparatus 32 to transport only one object 12 at a time. Alternatively, it is possible for a movement apparatus 32 to transport several objects 12 at a time. Alternatively, it is possible for several movement apparatuses 32 to transport an object 12 together, e.g., between each other.

Preferably, several movement apparatuses 32 are comprised (not shown in the figures for clarity). Particularly preferably, the several movement apparatuses 32 can be driven individually (e.g., magnetically or electromagnetically) and optionally moved independently of one another, e.g., via a long stator linear motor, a short stator linear motor, or a planar motor. Alternatively, electric motor(s) arranged on the movement apparatus 32 can also be used as a drive. The energy supply of these motors is preferably provided by a power storage device (battery) of the respective movement apparatus 32 or by wireless energy transmission or via energy transmission via sliding contact.

Preferably, the at least one movement apparatus 32 can be driven via (e.g., electro-) magnetic interaction with a stator.

Particularly preferably, the conveying device 30 is a long stator linear motor conveying device, as shown in FIGS. 1 and 2. The at least one movement apparatus 32 and the stator may together form a long stator linear motor drive system. The stator can be configured as a stationary long stator 34 with electromagnets or permanent magnets for effecting a movement or a drive of the at least one movement apparatus 32 equipped with permanent magnets. The long stator 34 can be formed from several long stator segments arranged next to one another.

However, it is also possible, for example, that the conveying device 30 is a short stator linear motor conveying device or a planar motor conveying device (not shown in the figures).

In the short stator linear motor conveyor, the at least one movement apparatus 32 and stationary permanent magnets may together form a short stator linear motor drive system. The at least one movement apparatus 32 can have a short stator formed by electromagnets, which can enter into magnetic interaction with stationary permanent magnets to drive the respective movement apparatus 32.

The planar motor conveying device can move the at least one movement apparatus 32 with at least two degrees of freedom (x-direction and y-direction) over a preferably planar drive surface of a stator via magnetic interaction with the stator. The movement apparatus 32 and the stator can together form a planar motor drive system. The stator can also be referred to as a platform or basic element. It is also possible that a lifting movement (z-direction) and/or a tilting movement of the at least one movement apparatus 32 relative to the stator / basic element can also be controlled via the magnetic interaction. The basic element can preferably be segmented into tiles. Preferably, the drive surface can be oriented horizontally or vertically. The stator can be formed, for example, by movable, e.g., rotatable, permanent magnets or by stationary electromagnets. The at least one movement apparatus 32 preferably has permanent magnets.

However, it is also possible that the at least one movement apparatus 32 is driven, for example, via a circulating conveying element, e.g., chain, belt or ring body. For example, the at least one movement device 32 can then be connected, preferably fixedly, to the circulating conveying element as at least one object carrier (not shown in the figures). A drive unit (e.g., an electric motor) can be connected to the circulating conveying element in a driving manner. In the case of several movement apparatuses 32, these can then only be moved and driven together via the circulating conveying element.

The at least one movement apparatus 32 comprises (in each case) an object holder 36, a connecting region 38 and a support connection 46. The at least one movement apparatus 32 can be arranged partly in the first space 18 and partly in the second space 20.

The object holder 36 is arranged in the second space 20. The object holder 36 is used to hold (at least) one object 12 to be transported. The object holder 36 can hold the object 12/the objects 12, for example, in a force-fitting and/or form-fitting manner.

Preferably, the object holder 36 can be a clamp (a gripper) or a rigid fitting. The clamp can be, for example, an active or a passive clamp. Preferably, the clamp can carry the object 12. For example, an object holder 36 can engage in a form-fitting manner with the object 12 in order to hold and preferably carry the object 12.

It is also possible that the object holder 36 is configured as a sliding element for sliding (carrying) an object 12. For example, the object holder 36 may have a body with a (vertically) uniaxially concavely curved receiving surface for a body or a neck of the object 12. The object 12 can be pushed by the object holder 36, for example, over a transfer plate or a conveyor belt, on which the object 12 is supported on the bottom side during the pushing.

Preferably, the object holder 36 is a container holder with which a container can be held and preferably carried. For example, the container holder can hold and carry the container by its container neck ring, as shown in FIGS. 1 and 2. Alternatively or additionally, the container holder can hold the container at its container shell and/or container base and optionally carry it. For example, the object holder 36 may have a container bottom support plate that can support a container on the bottom side.

The connecting region 38 is arranged in the first space 18. The connecting region 38 is used to connect the respective movement apparatus 32 such that the respective movement apparatus 32 is guided, supported and/or driven (i.e. at least one of guided, supported and driven).

For example, the connecting region 38 can have at least one (e.g., permanent) magnet 40, via which the respective movement apparatus 32 can be driven, e.g., via the long stator 34 (see FIGS. 1 and 2). Alternatively, the connecting region 38 can be attached, preferably detachably, to the circulating conveying element, with which the at least one movement apparatus 32 can thus be driven (not shown in the figures).

For example, the connecting region 38 can have at least one guide element 42. The at least one guide element 42 can be guided on the guideway 44 of the conveying device 30. The at least one guide element 42 can be designed, for example, as a roller or sliding shoe. Preferably, the at least one guide element 42 can also support the respective movement apparatus 32 on the guideway 44. Preferably, the at least one guide element 42 can be arranged in the first space 18.

Preferably, the guideway 44 can be a circumferential guideway. The guideway 44 can be, for example, a roller track, a slideway or a rail. Preferably, the guideway 44 may be arranged in the first space 18.

The support connection 46 connects the object holder 36 and the connecting region 38 to one another, preferably directly. Preferably, the object holder 36 can be supported on the connecting region 38 via the support connection 46.

The support connection 46 may be arranged partly in the first space 18 and partly in the second space 20. For example, the support connection 46 in the first space 18 can be immersed from above into the liquid channel 22 for immersion in the sealing liquid A. For example, the support connection 46 in the second space 20 can be immersed from above into the liquid channel 22 for immersion in the sealing liquid A. Preferably, the support connection 46 is spaced apart from the bottom and the side walls of the liquid channel 22 and optionally spaced apart from the partition wall 24.

A section of the support connection 46 extends through the liquid channel 22 for immersion in the sealing liquid A. Preferably, a longitudinal course of the section can extend through the liquid channel 22 in a beveled manner, preferably transversely, to a longitudinal course of the liquid channel 22.

The section can, for example, be a central section of the support connection 46. The section of the support connection 46 can, for example, be arranged between the object holder 36 and the connecting region 38.

Preferably, a cross-section of the liquid channel 22 and a longitudinal course of the section of the support connection 46 for immersing the section in the sealing liquid can be structurally adapted to each other. For example, the section of the support connection 46 may have a substantially U-shaped or a substantially V-shaped longitudinal course.

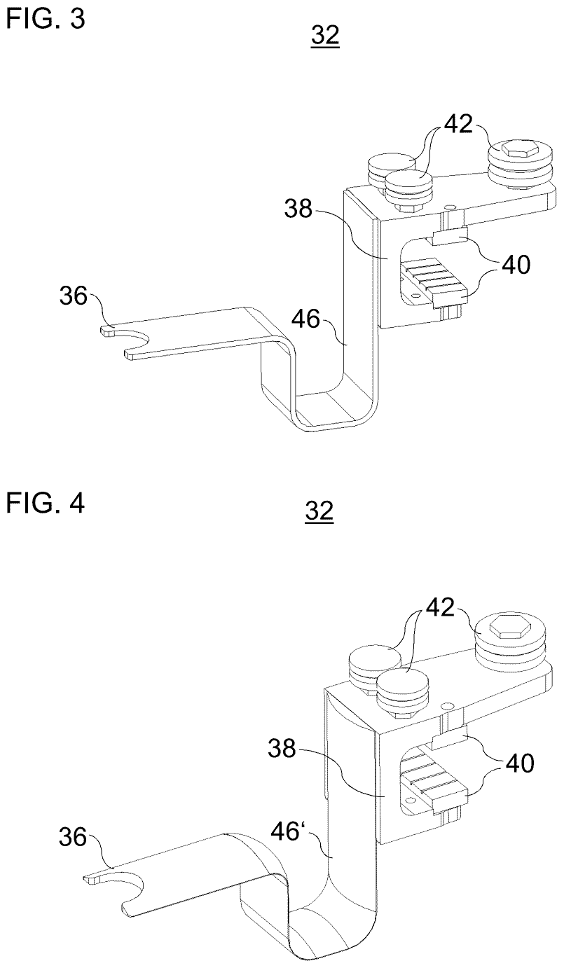

FIGS. 3 to 5 show that the section of the support connection 46 (46′, 46″) immersing into the liquid channel 22 preferably has a flow-optimized shape. The flow-optimized shape preferably results in the immersing section experiencing as little resistance as possible when moving through the sealing liquid A. Preferably, the flow-optimized shape is designed in such a way that the sealing liquid A sloshes as little as possible both when driving straight and when cornering.

FIG. 3 shows, by way of example, that the section of the support connection 46 immersing into the liquid channel 22 is formed as a flattened, bent sheet.

FIG. 4 shows, by way of example, that the section of the support connection 46 (46′, 46″) immersing into the liquid channel 22 is rounded or tapered. The rounding or tapered shape may be arranged on a side of the portion facing in a forward movement direction of the respective movement apparatus 32. Optionally, a rounding or tapered shape may also be comprised on an opposite side of the section.

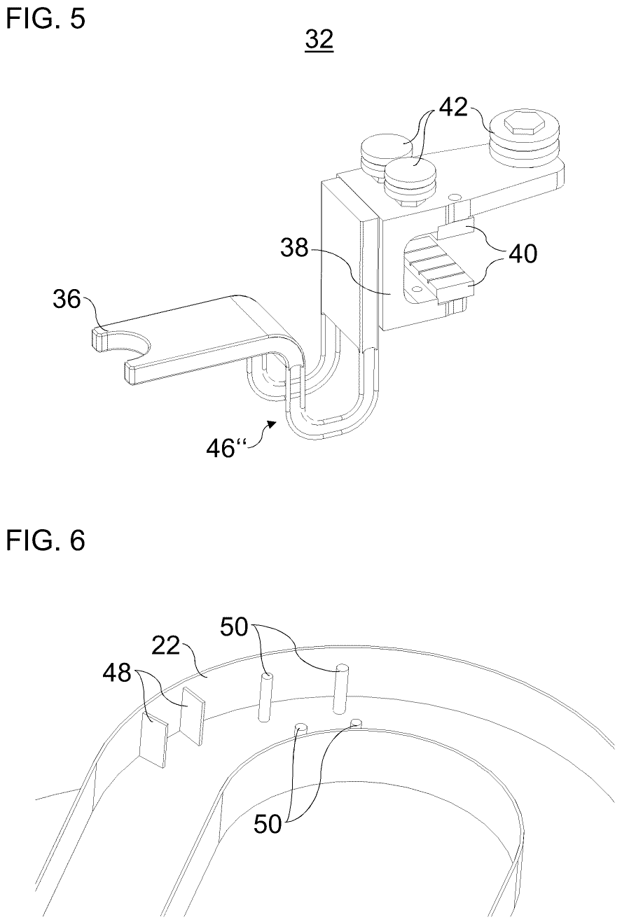

FIG. 5 shows, by way of example, that the section of the support connection 46 immersing into the liquid channel 22 can be designed as an open frame or bracket comprising several rod elements.

FIG. 6 shows a technique for preventing the sealing liquid A from spilling out of the liquid channel 22.

The region of the sealing device 16 shown in FIG. 6 is a region of the liquid channel 22. The sealing device 16 may have at least one damping element 48, 50 for damping a wave movement. The wave movement may be caused by the movement of the support connection 46 in the sealing liquid A in the liquid channel 22. The at least one damping element 48, 50 can act as a breakwater.

The at least one damping element 48, 50 may be arranged in the liquid channel 22. The at least one damping element 48, 50 may be arranged at the top, center and/or bottom of the liquid channel 22. Preferably, the at least one damping element 48, 50 is immersed in the sealing liquid A. Preferably, a plurality of damping elements 48, 50 are comprised, which are arranged distributed along a course of the liquid channel 22.

Preferably, the at least one damping element 48, 50 may be arranged in a curved section of the liquid channel 22, as shown by way of example in FIG. 6.

Preferably, the at least one damping element 48, 50 may be arranged in an edge region of the liquid channel. For example, the at least one damping element 48, 50 may be arranged directly adjacent to or directly connected to a side wall of the liquid channel 22. Preferably, a movement corridor for the immersed section of the support connection 46 can thus be kept substantially free throughout the center of the liquid channel 22.

The at least one damping element 48, 50 can be, for example, plate-shaped (see reference sign 48), e.g., in the form of a sheet, or rod-shaped (see reference sign 50). Other designs for damping a wave movement are also possible, e.g., block-shaped.

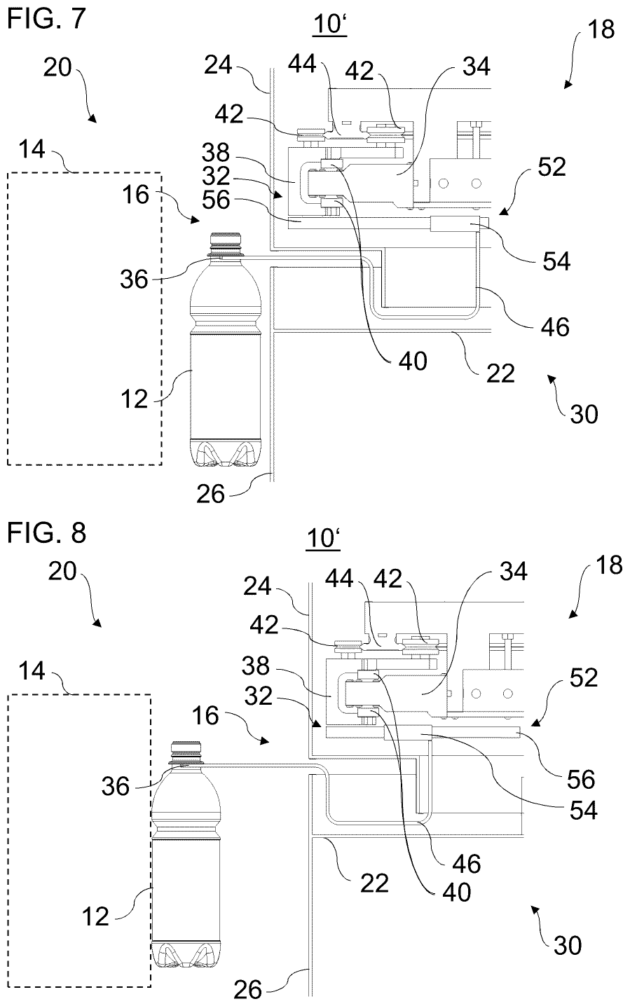

FIGS. 7 and 8 show a modified apparatus 10′in which, in addition to the mobility of the at least one movement apparatus 32 or the object 12 in a transport direction of the conveying device 30, at least one additional degree of freedom is provided for moving the object 12.

### In Particular, the Conveying Device 30 May Have an Adjusting Device 52.

Via the adjusting device 52, the object holder 36 and thus the object 12 held thereon can be moved at an angle, preferably transversely, to a longitudinal course of the liquid channel 22 or a transport direction of the conveying device 30.

Preferably, the adjusting device 52 enables a, preferably horizontal, displacement of the object holder 36. Accordingly, the adjusting device 52 can be a displacement device.

Alternatively or additionally, the adjusting device 52 can enable pivoting of the object holder 36, preferably about a pivot axis parallel or perpendicular to a longitudinal course of the liquid channel 22 and/or the transport direction of the conveying device 30. Accordingly, the adjusting device 52 can be a pivoting device. The pivoting device can, for example, have at least one swivel joint.

As shown by way of example in FIGS. 7 and 8, the adjusting device 52 is preferably integrated in the or in each movement device 32. For example, the adjusting device 52 can be integrated into the support connection 46. Alternatively, the adjustment device 52 can be integrated, for example, in the connecting region 38 or the object holder 36. Accordingly, the adjusting device 52 can move along with the respective movement apparatus 32.

By way of example, FIGS. 7 and 8 show the adjusting device 52 in a retracted position (FIG. 7) and in an extended position (FIG. 8).

The adjusting device 52 can, for example, have a displaceable carriage 54 which is integrated in the support connection 46. The carriage 54 may be displaced along a carriage guide 56. When the carriage 54 is displaced along the carriage guide 56, for example, the immersed section of the support connection 46 and the object holder 36 with the held object 12 are also displaced.

Alternatively, it is possible, for example, for the adjusting device 52 to be arranged externally of the at least one movement apparatus 32. For example, the adjusting device 52 could be arranged to move at least a section of the guideway 44 and optionally at least a section of the elongate stator 34. If a movement apparatus 32 is positioned at this movable section of the guideway 44, it can then be moved together with the respective object holder 36 and the respective object 12 held by the adjusting device 52 at an angle to a course of the guideway 44.

The adjusting device 52 can be operated in any conceivable way. For example, an electrical, electromagnetic, pneumatic, hydraulic or mechanical actuator may be comprised, which actuates the movement effected via the adjusting device 52.

For example, the actuator may be stationary, so that preferably a movement of the adjusting device 52 only takes place at one location, e.g., at the container treatment apparatus 14, preferably a filling station of the container treatment apparatus 14 for filling a container. Alternatively, the at least one movement apparatus 32 may, for example, comprise a control roller (cam roller) which rolls along a stationary control cam to generate the movement of the adjusting device 52.

Preferably, the adjusting device 52 can be arranged in the first space 18. Alternatively or additionally, the adjusting device 52 can be arranged, for example, in the liquid channel 22, e.g., immersed in the sealing liquid A. When arranged in the liquid channel 22, the adjusting device 52 can be arranged, for example, on one or both sides of the partition wall 24.

Preferably, the liquid channel 22 may have a widened section. The widened section may, for example, be widened relative to a preceding section and/or a subsequent section of the liquid channel 22. The widened section may be widened such that the immersing section of the support connection 46 can be accommodated within a movement space for the immersing section that can be effected by the adjusting device 52.

Preferably, the widened section of the liquid channel 22 is arranged adjacent to a container treatment apparatus 14. For example, a container held by the object holder 36 can be supplied to a treatment station (e.g., filling station or closing station) of the container treatment apparatus 14 by the movement (e.g., extension movement) effected by the adjusting device 52.

For example, the liquid channel 22 may have a transport section and an adjustment section (=widened section). The transport section can be narrower than the adjustment section/widened section. In the transport section, the objects 12 can be moved along a longitudinal course of the liquid channel 22 via the at least one movement apparatus 32. In the adjustment section (=widened section) a movement of the respective object 12 can be enabled via the adjusting device 52.

The invention is not limited to the preferred exemplary embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the dependent claims are also disclosed independently of all of the features of independent claim 1 and, for example, independently of the features relating to the presence and/or configuration of the sealing device, the conveying device, the object holder, the connecting region and/or the support connection of independent claim 1. All ranges specified herein are to be understood as disclosed in such a way that all values falling within the relevant range are individually disclosed, e.g., also as the relevant preferred narrower outer limits of the relevant range.

### LIST OF REFERENCE SIGNS

10 apparatus for transporting containers
12 object (e.g., container)
14 container treatment apparatus
16 sealing device
18 first space
20 second space
22 liquid channel
24 partition wall
26 additional partition walls
28 splash guard
30 conveying device
32 movement apparatus
34 long stator/long stator linear motor
36 object holder
38 connecting region
40 magnet
42 guide element
44 guideway
46 support connection
48 damping element
50 damping element
52 adjusting device
54 carriage
56 carriage guide
A sealing liquid

What is claimed is:

1. An apparatus for transporting objects, wherein the apparatus comprises:
a sealing device, wherein the sealing device seals between a first space and a second space and, for sealing, has a liquid channel for accommodating a sealing liquid;
a conveying device with at least one movement apparatus for transporting an object, wherein the at least one movement apparatus comprises:
an object holder for holding the object, wherein the object holder is arranged in the second space;
a connecting region for at least one of guiding, driving and supporting the respective movement apparatus, which is arranged in the first space; and
a support connection connecting the connecting region and the object holder to one another, wherein a section of the support connection extends through the liquid channel for immersion in the sealing liquid.

2. The apparatus according to claim 1, wherein at least one of the following is met:
the conveyor device has several movement apparatuses which are drivable and movable; and
the conveying device is a long stator linear motor conveying device, a short stator linear motor conveying device, a planar motor conveying device or a conveying device with a circulating conveying element, wherein the circulating conveying element is connected to the at least one movement apparatus.

3. The apparatus according to claim 1, wherein:
the conveying device has a guideway which is arranged in the first space; and
the connecting region of the respective movement apparatuses has at least one guide element which is guided on the guideway for guiding the respective movement apparatus along the guideway, wherein the at least one guide element is arranged in the first space.

4. The apparatus according to claim 3, wherein at least one of the following is met:
the guideway and the liquid channel extend next to one another;
the liquid channel is arranged outside or inside of the guideway; and
the at least one guide element carries the respective movement apparatus on the guideway.

5. The apparatus according to claim 1, wherein at least one of the following is met:
a cross-section of the liquid channel and a longitudinal course of the section of the support connection are structurally adapted to each other for immersion of the section in the sealing liquid;
the liquid channel has a substantially U-shaped or a substantially V-shaped cross-section;
the section of the support connection has a substantially U-shaped or a substantially V-shaped longitudinal course; and
the liquid channel is filled or can be filled with the sealing liquid.

6. The apparatus according to claim 1, wherein:
the liquid channel is open at the top;
the support connection in the first space is immersed from above into the liquid channel for immersion in the sealing liquid; and
the support connection in the second space is immersed from above into the liquid channel for immersion in the sealing liquid.

7. The apparatus according to claim 1, wherein:
the sealing device has a partition wall which separates the first space and the second space from one another and which is immersed in the liquid channel for immersion in the sealing liquid.

8. The apparatus according to claim 1, wherein:
the sealing device comprises at least one damping element which is formed in the liquid channel for damping waves of the sealing liquid caused by the movement of the support connection in the liquid channel.

9. The apparatus according to claim 1, wherein at least one of the following is met:
the objects are containers;
the sealing device is a water lock;
the sealing device liquid channel is circumferential;
the sealing device has a partition wall which separates the first space and the second space from one another and which from above is immersed in the liquid channel for immersion in the sealing liquid;
the partition wall of the sealing device is stationary;
the partition wall of the sealing device is circumferential;
a section of the partition wall immersed in the liquid channel and the liquid channel together form a siphon;
a longitudinal course of the partition wall of the sealing device extends as a parallel curve to the liquid channel;
a splash guard is connected to the partition wall of the sealing device to prevent sealing liquid from splashing out of the liquid channel in the second space;
a circumferential splash guard is connected to the partition wall of the sealing device to prevent sealing liquid from splashing out of the liquid channel, preferably;
several damping elements are comprised, which are arranged distributed along a longitudinal course of the liquid channel;
the at least one damping element formed in the liquid channel is one of rod-shaped, plate-shaped and block-shaped;
the at least one damping element formed in the liquid channel is arranged in a curved section of the liquid channel; and
the at least one damping element formed in the liquid channel is arranged in an edge region of the liquid channel to leave a movement corridor for the section of the support connection.

10. The apparatus according to claim 1, wherein at least one of the following is met:
the section of the support connection has a flow-optimized shape in order to minimize wave formation when moving through the sealing liquid;
the section of the support connection is designed as a bent sheet, a bracket or an open frame;
the section of the support connection is flattened; and
a side of the section of the support connection facing in a forward movement direction of the respective movement device is rounded or tapered.

11. The apparatus according to claim 1, further comprising:
an adjusting device which is configured to move the object holder at an angle to a longitudinal course of the liquid channel.

12. The apparatus according to claim 11, wherein at least one of the following is met:
the adjusting device is integrated in the at least one movement apparatus, or the adjusting device is configured to move at least a section of a guideway of the conveying device on which the at least one movement apparatus is guided;
the adjusting device is arranged in at least one of the first space and the liquid channel;
the adjusting device is at least one of a displacement device and a pivoting device; and
the liquid channel has a widened channel section for receiving the section of the support connection within a movement space for the section of the support connection which can be effected by the adjusting device.

13. The apparatus according to claim 11, wherein at least one of the following is met:
the adjusting device is configured to at least one of displace and pivot the object holder at the angle to the longitudinal course of the liquid channel;
the adjusting device is configured to move the object holder transversely to the longitudinal course of the liquid channel;
the adjusting device is integrated in the support connection.

14. The apparatus according to claim 1, wherein at least one of the following is met:
the second space is a processing space in which the objects can be treated;
the second space is a clean room;
the first space is a drive space in which drive technology for driving the at least one movement apparatus is arranged, and
the first space is open to the surroundings.

15. The apparatus according to claim 1, wherein at least one of the following is met:
the object holder is a container holder for holding a container;
the object holder has a sliding element for sliding an object; and
the object holder has a clamp.

16. The apparatus according to claim 1, wherein at least one of the following is met:
the conveyor device has several movement apparatuses which are individually drivable and independently movable;
the conveying device is one of a long stator linear motor conveying device, a short stator linear motor conveying device, a planar motor conveying device and a conveying device with one of a chain, a belt and a ring body;
the conveying device has a circumferential guideway which is arranged in the first space;
the conveying device has a guideway that extends next to the liquid channel as substantially parallel curves;
the liquid channel is filled or can be filled with the sealing liquid having at least one of water, a sterilizing agent, and a disinfectant;
the second space is a clean room which is applied with or can be applied with at least one of filtered air, sterile air and an overpressure;
the first space is a drive space in which lubricated drive technology for driving the at least one movement apparatus is arranged;
the object holder is a container holder for holding a container on at least one of a container neck, a container neck ring, a container shell and a container bottom of the container;
the object holder has an active or passive clamp; and
the object holder has a container clamp.

17. A container processing system, having:
an apparatus according to claim 1; and
a container treatment apparatus for treating containers, which is arranged at least in sections in the second space,
wherein:
the at least one movement apparatus for transporting an object designed as a container to the container treatment apparatus, is movable at least one of along the container treatment apparatus and away from the container treatment apparatus.

18. The container processing system according to claim 17, wherein the container treatment apparatus is one of:
a container production apparatus for producing the containers,
a coating apparatus for coating the containers,
a cleaning device for cleaning the containers,
a sterilization device for sterilizing the containers,
a filling device for filling the containers with a filling material,
a closing device for closing the containers,
a labeling device for labeling the containers, and
a printing device for printing on the containers.

19. A method for transporting objects, wherein the method comprises:
sealing between a first space and a second space via a liquid channel of a sealing device filled with a sealing liquid; and
transporting an object within the second space via an object holder of a movement apparatus of a conveyor device, wherein:
the movement apparatus is at least one of guided, driven and supported via a connecting region of the movement apparatus, which is arranged in the first space, and
the movement apparatus has a support connection which connects the object holder and the connecting region and has a section which is immersed in the sealing liquid.

20. A method for transporting objects via the apparatus according to claim 1, wherein the method comprises:
sealing between a first space and a second space via a liquid channel of a sealing device filled with a sealing liquid;
transporting an object within the second space via an object holder of a movement apparatus of a conveyor device, wherein:
the movement apparatus is at least one of guided, driven and supported via a connecting region of the movement apparatus, which is arranged in the first space;
the movement apparatus has a support connection which connects the object holder and the connecting region and has a section which is immersed in the sealing liquid;
the object is a container; and
treating the transported object in the second space via a container treatment apparatus.
